(19) United States
(12) Patent Application Publication
(10) Pub. No.: US 2012/0220465 A1
(43) Pub. Date: Aug. 30, 2012

(54) MgB2 SUPERCONDUCTIVE WIRE

(75) Inventors: Kazuhide TANAKA, Hitachi (JP); Yasuo Kondo, Hitachinaka (JP); Tsuyoshi Wakuda, Hitachinaka (JP)

(73) Assignee: HITACHI, LTD.

(21) Appl. No.: 13/372,555

(22) Filed: Feb. 14, 2012

(30) Foreign Application Priority Data
Feb. 25, 2011 (JP) 2011-039173

(51) Int. Cl. H01B 12/02; H01B 13/00

(52) U.S. Cl. 505/231; 505/430; 505/230; 427/62; 264/104; 174/125.1; 423/289; 29/599

(57) ABSTRACT

The invention provides a MgB₂ superconductive wire which is long and has a high critical current density. The invention provides a manufacturing method of a superconductive wire in which a magnesium or a magnesium alloy is reacted with a magnesium boride expressed by MgBx (x=4, 7, 12) by carrying out a heat treatment. A superconductive wire is characterized by the magnesium boride expressed by the MgBx (x=4, 7, 12) is included in a part.

### BACKGROUND OF THE INVENTION

(1) Field of the Invention

The present invention relates to a magnesium diboride superconductive wire.

(2) Description of Related Art

As a general method which is applied to a manufacturing of a magnesium diboride (MgB₂), there is mainly employed a powder in tube (PIT) method which is suitable for an industrialization. The PIT method is roughly classified into two methods including (i) an ex-situ method of filling a MgB₂ powder in a metal pipe so as to carry out a wire drawing process, and (ii) an in-situ method of filling a mixed powder of Mg and B in a metal pipe so as to carry out a wire drawing process, and thereafter forming a superconducting by a heat treatment.

In the case of the ex-situ method, it is a reaction between the MgB₂ grains. Accordingly, a heat treatment for a long time at a high temperature is substantially unavoidable. In the heat treatment step, since the high temperature and the long time cause a cost increase, they are not preferable on application. Further, they are greatly affected by a characteristic of the filled MgB₂ superconducting powder. Specifically, if an oxide film is formed on a surface of the MgB₂ powder, a different phase is generated on an interface of the powder grain at a time of a final heat treatment, and interrupts an electric current path. Further, the Mg having a high vapor pressure is evaporated during the heat treatment, and a composition slippage (Mg-poor) is caused. In accordance with this, a high Jc formation has a greater problem in comparison with the in-situ method at this stage.

On the other hand, in the case of the in-situ method, a method of creating the MgB₂ on the basis of a diffusion reaction between the Mg powder and the B powder is general. Taking into consideration this reaction aspect (Mg+2B→MgB₂), since each of the powders of Mg: 14×10⁻³ m³/mol and 2B: 9×10⁻³ m³/mol in mole volume is changed to MgB₂: 17×10⁻³ m³/mol in accordance with the heat treatment, a sintered density is reduced about 26%. Therefore, there is such a problem that it is hard to make a density in the wire core high.

In patent document 1 (JP-A-2008-140556), as a method of holding down a reduction of a sintered density as much as possible, there has been made a study of a MgB₂ wire forming method of attaching a product material constituted by a Mg grain and a B grain having a smaller grain diameter to a surface of a Mg grain having a larger grain diameter, and producing a MgB₂ in accordance with a heat treatment.

However, in the patent document 1, there is provided such a reaction mode that the Mg having the large grain diameter in the heat treatment step is diffused to the product side which is constituted by the Mg grain and the B grain having the smaller grain diameter. As a result, an area of the Mg grain which originally exists and has the large grain diameter comes to a void. Since the wide area in the inner portion of the wire comes to the void, a mechanism strength is lowered, and the Jc in a magnetic field is widely lowered. In accordance with this, a performance which the MgB₂ has by nature can not be derived.

### BRIEF SUMMARY OF THE INVENTION

The present invention is made by taking the circumstance mentioned above into consideration, and an object of the present invention is to provide a MgB₂ superconductive wire which can simultaneously achieve a long wire formation and a high Jc formation which are necessary for forming a practical wire.

The present invention is a manufacturing method of a superconductive wire characterized in that a magnesium boride expressed by MgBx (x=4, 7, 12) is reacted with a magnesium or a magnesium alloy by carrying out a heat treatment. Particularly, it is preferable that the MgBx is filled in a tube made of a magnesium or a magnesium alloy and a heat treatment is carried out.

A superconductive wire in accordance with the present invention is characterized in that a magnesium boride expressed by MgBx (x=4, 7, 12) is partly included. Particularly, it is preferable that it is such a shape that the MgBx (x=4, 7, 12) is left like a core in a center portion, and the MgB₂ is produced therearound.

### Effect of the Invention

In accordance with the structure mentioned above, it is possible to simultaneously achieve the long wire formation and the high Jc formation of the MgB₂ superconductive wire.

Other objects, features and advantages of the invention will become apparent from the following description of the embodiments of the invention taken in conjunction with the accompanying drawings.

### BRIEF DESCRIPTION OF THE SEVERAL VIEWS OF THE DRAWING

FIG. 1 is a flow chart showing a manufacturing process of a MgB₂ superconductive wire;

FIG. 2 is a schematic view showing a change of a cross section before and after a heat treatment of the MgB₂ superconductive wire; and

FIG. 3 is a view showing a magnetic field dependency of a critical current density of the MgB₂ superconductive wire.

### DETAILED DESCRIPTION OF THE INVENTION

Entering into twenty first century, it has been found that the magnesium diboride (MgB₂) exhibits a superconducting at 39 K (Nature 410, 63-64 (2001)). The following features have been mainly known in the magnesium diboride (MgB₂).

(1) A critical temperature (hereinafter, refer to as Tc) is 39 K, which is 20 K or more higher than the conventional metallic superconductor.

(2) An upper critical magnetic field (hereinafter, refer to as Hc2) is about 20 T or more, which is more excellent than the conventional metallic superconductor.

(3) A transfer critical current density (hereinafter, refer to as Jc) is in the order of 1000 A/mm² in an applied magnetic field.

(4) A magnetic anisotropy is small, and it is possible to circulate the same electric current in all directions of an axis a, an axis b and an axis c of a crystal.

As mentioned above, since the MgB₂ superconductor appears a high superconductivity in both of the Tc and the Hc2, in comparison with the conventional metallic superconductor, a high superconductive critical current density can be obtained in the MgB₂ superconductive wire under an environment which is equal to or lower than the critical temperature.

If it is applied to a superconducting magnet, it is possible to construct an extremely stable system having no quenching accident. Specifically, it can be applied to an equipment such as a current lead, a power cable, a large size magnet, a nuclear magnetic resonance analyzing apparatus, a medical magnetic resonance diagnosing apparatus, a superconductive power storage apparatus, a magnetic separating apparatus, a magnetic single crystal pulling apparatus, a refrigerator cooling superconducting magnet apparatus, as superconducting energy storage, a superconducting power generator, a magnet for a nuclear fusion reactor, and the like.

As items which are essential for manufacturing a superconductive wire having a high performance, the following four items are particularly important.

(1) selection of a metal sheath which is not reacted with the superconductor in a metallurgical manner;

(2) improvement of a superconductor filling density at a time of processing to a final shape;

(3) improvement of a bonding property between the crystal grains; and

(4) introduction of a pinning center for making an intruding magnetic flux wire immobile by trapping a quantized magnetic flux wire.

The superconductive wire having the high characteristic can be obtained by simultaneously achieving the items mentioned above.

However, the Jc is not a value which is specific for the material, but greatly depends on a structure of a wire core portion and a manufacturing method of the wire. In accordance with this, it has been known that the Jc of the MgB₂ superconductive wire is not improved so much only by the manufacturing method which has been applied to the conventional metallic superconductive wire and oxide superconductive wire. Accordingly, it is necessary to optimize respectively in correspondence to the superconducting materials, and it is necessary to independently make a study of the MgB₂ superconductor.

Accordingly, the inventors of the present invention have devoted themselves to make a study of a manufacturing method of the MgB₂ superconductive wire which can achieve the object. As a result, they have found a means for achieving the object. A long wire having a high Jc can be easily manufactured whatever shape the wire is formed, by applying the means.

In other words, it is the MgB₂ superconductive wire in which the MgB₂ is produced by using the Mg and the MgBx (x=4, 7, 12) as a starting material and carrying out a heat treatment. The starting material including the MgBx (x=4, 7, 12) is filled in the Mg or Mg alloy tube, and the MgBx (x=4, 7, 12) is left after the heat treatment for the superconducting. It is preferable that an unreacted B does not exist in a cross section micro structure after the heat treatment for the superconducting. The MgB₂ powder may be mixed into the starting raw material at least equal to or more than 1 weight % and equal to or less than 5 weight %. It is preferable that a temperature of the heat treatment for superconducting is higher than 650° C. which is a melting point of Mg, and is lower than a decomposition temperature of the MgB₂, and an upper limit thereof is 1300° C.

In the superconductive wire which is obtained by the method mentioned above, the MgBx (x=4, 7, 12) is left like a core in the center portion, in the cross section micro structure after the heat treatment for the superconducting, and the MgB₂ is produced therearound. Further, they are continuously connected in a longitudinal direction of the wire. The MgBx (x=4, 7, 12) left like the core contributes as a pinning center.

In accordance with the structure mentioned above, there can be obtained the MgB₂ superconductive wire having the high superconducting characteristic which is necessary for forming the practical wire. The equipment can be operated by the cooling on the basis of a liquid hydrogen, a refrigerator conduction cooling or the like, in addition to the cooling by a liquid helium, and a high superconducting property can be obtained even in a high magnetic field area.

In order to describe in detail, a description will be given of operations and various modes on the basis of the accompanying drawings. In this case, the present invention is not limited to them.

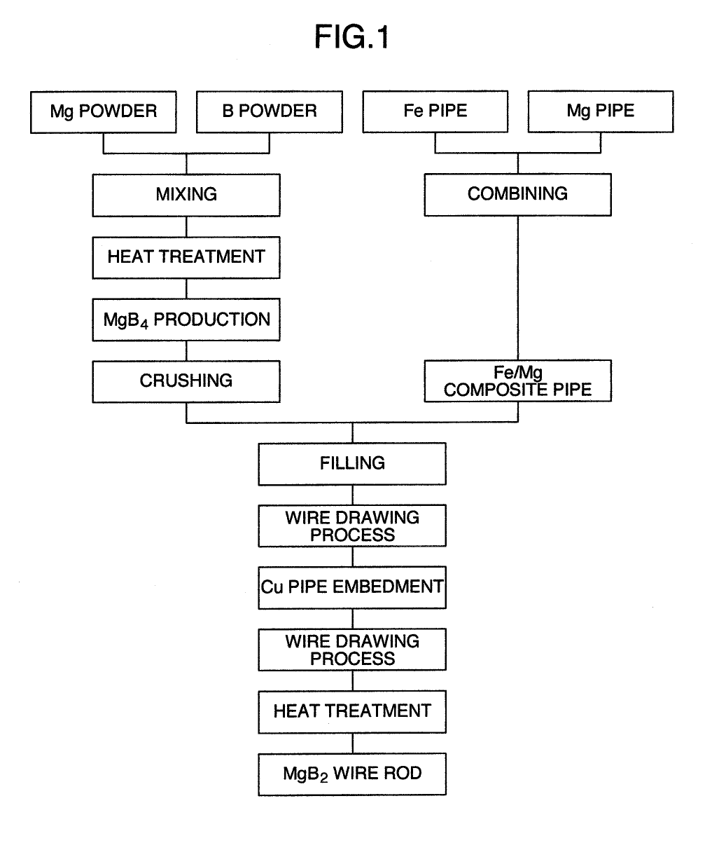

FIG. 1 shows an example of a manufacturing method of a superconductive wire by a flow chart. First of all, the MgBx coming to a raw material is manufactured. After weighing in such a manner that a predetermined atomic mole ratio comes to 1:4 by using the Mg powder and the B powder, both of them are mixed, and the obtained mixed powder is thermally treated at a temperature between 800 and 1200° C. The MgB₄ compound constructed by the Mg and the B is obtained by this heat treatment. Next, the superconductive wire is manufactured by using the obtained MgB₄ compound. The MgB₄ compound is crashed, is filled in a Fe/Mg complex sheath pipe in which a pure Fe is arranged in an outer peripheral portion and a pure Mg is arranged in an inner peripheral portion, is applied a wire drawing process to a diameter of the wire of 0.5 to 2 0 mm, and is thereafter separated into nineteen pieces. This is assembled again in the Cu pipe, is applied a wire drawing process to a diameter of the wire of 0.5 to 1.2 mm, and is thereafter thermally treated at 650 to 900° C., whereby the superconductive wire is obtained.

In the description mentioned above, the example is structured such that the wire is manufactured by using the PIT method of applying a plastic processing by filling the powder in the pipe shaped metal sheath member, however, there may be employed a rod in tube method or the like of applying a plastic processing by filling a pressed powder forming body forming the powder in the pipe shaped metal sheath member. Since the superconductor and the metal sheath member are thermally reacted and there is a risk that the Jc is lowered, it is preferable to select a material which does not react with the superconductor, for the metal sheath member which directly comes into contact with the superconductor.

It is possible to employ a drawing bench, a hydrostatic extrusion, a swage, a cassette roller die or a groove roll, for the wire drawing process which is carried out for reducing the diameter of the wire, and the wire drawing process in which a cross section reducing rate per 1 path is between about 8 and 12% is repeatedly carried out. Further, in order to carry out an improvement of a bending characteristic and a high density formation of the superconductive core portion, a multiple core formation is carried out as occasion demands as mentioned above. At a time of the multiple core formation, the wire which is drawn in a round cross sectional shape or a hexagonal cross sectional shape is embedded in the metal pipe for the multiple core formation.

In the wire manufactured as mentioned above, the MgB₂ is formed continuously in a longitudinal direction of the wire. The MgB₄ may be left in the center portion in an average diameter which is equal to or less than 0.1 to 3.0 μm.

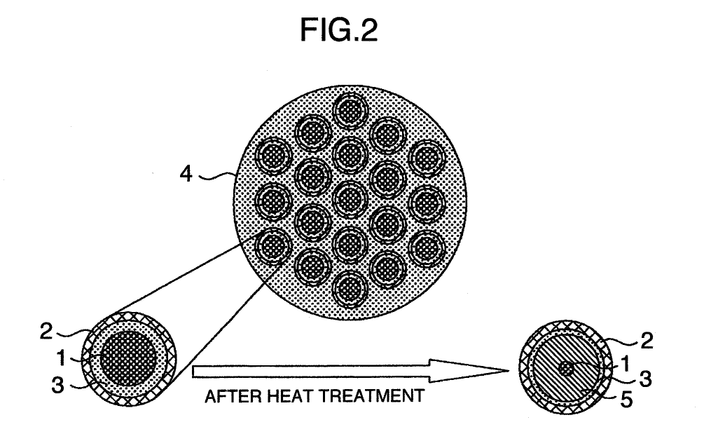

FIG. 2 is a schematic view showing a cross section change of the multiple cored MgB₂ wire before and after the heat treatment. As the raw material powder, a MgB₄ compound 1 in which the Mg and the B are thermally treated so as to be combined is used. If an average grain diameter is made equal to or less than 10 μm by crushing this by a ball mill or the like, it is effective in the light of the reaction property. A void in the Fe/Mg pipe (the outer periphery: Fe pipe 2, the inner periphery: Mg pipe 3) generated at a time of filling the MgB₄ powder is filled up little by little in accordance with the drawing process thereof, the powders come into close contact with each other, and the void is going to be lowered. A multiple cored wire having a plurality of superconductive filaments 6 is formed by again filling a plurality of drawn wires in the Cu pipe 4. If the multiple cored wire is drawn until the final diameter comes to the diameter of 0.5 mm, a void ratio comes to about 15%.

If a heat treatment is carried out at a predetermined temperature after the drawing process, the Mg is going to be diffused to the MgB₄ side, and the MgB₂ superconductor 5 is formed. Since the Mg of the sheath is diffused, a thickness of the sheath is reduced on the basis of the heat treatment. Accordingly, a cross section design is necessary while taking a thickness reducing amount into consideration.

The produced wire can be spirally wound by being combined two or more in correspondence to the purpose, and can be utilized by being formed as a lead wire shape or a cable wire shape. In addition to the method mentioned above, even if the superconductor is manufactured by using the MgBx and the magnesium as the raw material, for example, in accordance with a thermal spraying method, a doctor blade method, a dip coating method, a spray pyrolysis method, a jelly roll method or the like, a high superconducting property can be obtained.

A description will be further in detail given below of the present invention on the basis of embodiments.

### Embodiment 1

The Mg and the B are weighed in such a manner that they come to 1:4 in an atomic ratio, by using the magnesium powder (purity of Mg: 98% or more) having an average grain diameter of 45 μm and an amorphous boron powder (purity of B: 95% or more) having an average grain diameter of 1 μm, and are mixed for three hours in an argon atmosphere by using a planetary ball mill. In the present embodiment and the following embodiment, the materials of the container and the ball used at a time of mixing are all made of ZrO₂. The MgB₄ powder is manufactured by filling the obtained mixed powder in the container formed by a niobium (Nb) sheet, putting a lid by a Nb plate, and thermally treating at 970° C. under the argon atmosphere. In the present embodiment, the heat treatment is carried out under a decompression between 0.1 and 1 Torr. As a result of calculating a MgB₄ producing rate from an X-ray diffraction intensity, it is about 98%. The MgB₄ powder obtained by the heat treatment is crushed for thirty minutes in the argon atmosphere by the planetary ball mill.

In parallel with this, an Fe/Mg composite pipe is manufactured by combining an iron (Fe) pipe having an outer diameter 15 mm, an inner diameter 13 mm and a length 600 mm, with a magnesium (Mg) pipe having an outer diameter 12 mm, an inner diameter 8 mm and a length 600 mm. The MgB₄ powder is filled after sealing one end of the composite pipe. After the filling, the wire drawing process of the Fe/Mg composite pipe sealed in one end is repeated in such a manner that a cross sectional area reducing rate per one path comes to a range between 8 and 12%, and the wire drawing process is carried out to the diameter of the wire of 2.0 mm. All the wires can be processed with no disconnection without any annealing during the process. The processed wire is cut into nineteen pieces, and they are embedded in the cupper (Cu) pipe having an outer diameter 14 mm, an inner diameter 11 mm and a length 300 mm, thereby forming a wire having a multiple core (nineteen core) structure.

The wire drawing process is repeated in such a manner that the cross sectional area reducing rate per one path comes to a range between 8 and 12%, and the wire drawing process is carried out to the diameter of the wire of 1.2 mm. The processed wire is formed as the MgB₂ superconductive wire by being thermally treated at 670° C. in the argon atmosphere. Cutting the wire before and after the superconducting thermal treatment at random and observing a cross section thereof by using a scanning electron microscope (SEM), it has been known that the Mg in the sheath member is diffused to the MgB₄ powder side, and the MgB₂ is produced. As a result of measuring the Tc of the obtained wire, it is between 37 and 38 K.

The performance of the wire is checked by adjusting the diameter of the core portion of the unreacted MgB₄ in the cross section. The diameter of the MgB₄ is controlled by increasing or decreasing the time at a heat treatment temperature of 670° C. There are manufactured five kinds of wires in which the diameter of the core portion of the MgB₄ is 0 (no core), 0.2, 0.5, 1.0 and 3.0 μm. Fifty hours is necessary in order to set the diameter to 0, and five hours is necessary in order to set it to 3.0 μm.

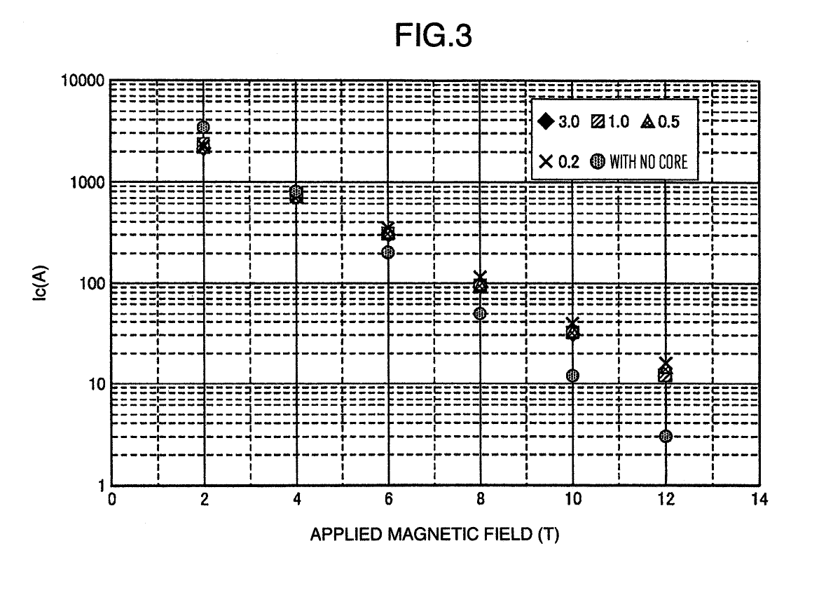

As a result, it has been known that the critical current (Ic) is changed in accordance with the diameter (the rate) of the core portion of the unreacted MgB₄ which is left in the cross section as shown in FIG. 3. In other words, in order to improve the Ic in the high magnetic field area, it is desirable to leave the unreacted MgB₄ in the center of the cross section, and it is further desirable to make it equal to or less than 3.0 μm. Further preferably, it is further effective to make it finer to nm level which is equal to or less than 1 μm. If the diameter is equal to or more than 3.0 μm, the rate of the MgB₄ occupied in the cross section core of the wire is increased. As a result, since a rate of the superconductive MgB₂ is reduced, the superconducting performance is lowered.

Further, a magnetic field dependency of Ic is smaller in the case that the MgBx is left as the core, as shown in FIG. 3. The left MgB₄ is continuously formed in the longitudinal direction of the wire, and contributes as the pinning center. The diameter of the MgB₄ equal to or less than 3.0 μm is effective, however, in the case that the grain diameter of the MgB₄ is fine, a producing amount of the MgB₂ is relatively increased. Accordingly, the MgB₂ producing amount is higher in Ic as shown in FIG. 3. In this case, in the case that it is not connected continuously in the wire longitudinal direction (in the case that a position having zero core exists), the magnetic field dependency of Ic becomes the same as the case that the diameter of the core is zero, and the Ic in the magnetic field becomes lower.

On the other hand, it is known that in the case that the MgB₄ is not left at all, the Ic in the low magnetic field region becomes higher, however, since the pinning center does not exist in the high magnetic field area, the reduction of Ic is great.

Same applies to the case that an MgB₇ or an MgB₁₂ mentioned below is employed, the MgBx (x=4, 7, 12) is left like a core in the center portion after the heat treatment for the superconducting by using the Mg and the MgBx (x=4, 7, 12) as the starting raw material, and carrying out the heat treatment, and the high Ic can be obtained by forming a cross section micro structure in which the MgB₂ is produced therearound. It becomes apparent that the MgBx (x=4, 7, 12) contributes as the pinning center, and contributes to an improvement of the Ic property in the high magnetic field region. Further, the left MgBx (x=4, 7, 12) is further effective in the light of the Ic property, by being formed such a cross section that the grain diameters of nm size are connected continuously in the longitudinal direction.

The micro structure of the wire in accordance with the present embodiment is searched in detail. As a result, it is known that the unreacted B does not exist at all in the superconductive core portion after the heat treatment of the wire. In the conventional in-situ method of producing the MgB₂ from the mixed powder of the magnesium and the boron, the unreacted boron is left. It is estimated to be caused by a reason that a distance between the Mg and the B is away and both the elements can not carry out a diffusion reaction, or a part of the Mg comes to MgO and a supply amount of the Mg for producing the MgB₂ on the basis of the reaction with the boron runs short. Since the B left in the MgB₂ superconductive wire interrupts the current path, and causes the reduction of Ic, it is not preferable. In the present embodiment, since the heat treatment is executed under a condition that the unreacted B is not left at a time of producing the MgBx (x=4, 7, 12), it is deemed that it is possible to do away with the unreacted B. The matter that the unreacted boron is not included is one of the reasons why the Ic of the wire in accordance with the present embodiment is improved.

### Embodiment 2

The wire is manufactured by structuring in the same manner as the embodiment 1 except a matter that the filling powder described in the embodiment 1 employs a MgB₇ or a MgB₁₂ is used in place of the MgB₄. The MgB₇ or the MgB₁₂ is left like a core in a center portion, and there is obtained a wire in which the MgB₂ is produced therearound. As a result, even in the case that the MgB₇ or the MgB₁₂ is used as the raw material powder, approximately the same result can be obtained in the property of the superconductive wire.

### Embodiment 3

The wire is manufactured by structuring in the same manner as the embodiment 1 except a matter that the Mg pipe described in the embodiment 1 is changed to a magnesium-lithium (Mg—Li) alloy pipe. The Ic is about 20% lowered in comparison with the case that the Mg pipe is used. Specifically, the Ic at 4.2 K in 10 T is 39 A in the case that the Mg pipe is used, however, is lowered to 31 A in the case that the Mg—Li alloy pipe is used. The reason is that the compound of Li and B is formed.

However, a workability of the multiple cored wire is significantly improved. In other words, in the case that the Mg pipe is used, the disconnection is frequency generated if the diameter of the wire becomes equal to or less than 0.4 mm, and it is impossible to process any more, however, in the case that the Mg—Li alloy pipe is used, the disconnection is not generated even after processing until it comes to 0.3 mm.

Accordingly, it is possible to widely improve the workability at a time of manufacturing the superconductive wire, by applying the alloy pipe made of the magnesium alloy.

In addition to Li, the workability can be improved in the same manner by applying an alloy pipe including Al, Ag, Au, Sn or Zn having a weight % equal to or less than 15% to the Mg.

### Embodiment 4

The present embodiment describes an example in which a wire is manufactured by adding the MgB₂ to the raw material powder in addition to the magnesium and the MgB₄. Nine kinds of wires are manufactured by structuring in the same manner as the embodiment 1, except a matter that the MgB₂ is 0 to 90% added to the filling powder described in the embodiment 1. Table 1 shows the Ic and the void ratio in the cross section at 4.2 K and in 10 T of the respective wires. The void ratio is determined by imaging a transverse cross section of the wire, and image analyzing a filament portion in which the superconductor exists.

TABLE 1
Relationship between adding amount of MgB₂, and Ic and void ratio

| | Adding amount of MgB₂ with | | | | | | | | |
|---|---|---|---|---|---|---|---|---|---|
| | respect to MgB₄ (weight %) | | | | | | | | |
| | 0 | 0.5 | 1 | 5 | 10 | 30 | 50 | 70 | 90 |
| Ic at 4.2 K and 10 T (A) | 39 | 38 | 46 | 48 | 49 | 51 | 50 | 35 | 33 |
| Void ratio in cross section (%) | 24 | 23 | 22 | 21 | 19 | 17 | 12 | 10 | 9 |

The Ic is increased if the adding amount of MgB₂ goes beyond 1 weight %. Further, the void ratio is reduced in conjunction with the adding amount of MgB₂. Taking into consideration the reaction Mg+MgB₄→MgB₂, since the specific gravity is increased at a time of coming to the MgB₂, it comes to a calculation in which the void ratio of 15% is theoretically generated. Since the MgB₂ is not changed its specific gravity before and after the heat treatment if the MgB₂ is added thereto, the void ratio becomes relatively small. However, as shown in Table 1, if a lot of MgB₂ is added from the beginning, it is known that the Ic is rather lowered. The reduction of Ic is generated from an area in which the adding amount of the MgB₂ goes beyond 50 weight %.

Accordingly, it suggests that the better MgB₂ is produced in the case that the MgB₂ is produced from Mg+MgB₄. In accordance with the present embodiment, it is known that it is possible to produce the MgB₂ superconductive wire having the smaller void ratio and the higher Ic, by including the MgB₂ powder equal to or more than 1 weight % and equal to or less than 50 weight %, in the MgB₄ of the filling powder.

### Embodiment 5

The present embodiment is an example obtained by making a study of a heat treatment condition of the superconductive wire. In the same manner as the embodiment 1, the multiple cored wire having nineteen cores is manufactured. The heat treatment temperature for superconducting is made just below or just above the melting point (650° C.) of the Mg, and a retaining time at the temperature is adjusted. In this case, the heat treatment is carried out under the argon atmosphere. Table 2 shows a relationship between the heat treatment condition (the temperature and the time) and the Ic at 4.2 K and in 10 T of the obtained superconductive wire.

TABLE 2

| | Heat treatment temperature | | | | | | |
|---|---|---|---|---|---|---|---|
| | 660° C. | 655° C. | 655° C. | 655° C. | 645° C. | 645° C. | 600° C. |
| Heat treatment | six hours | ten hours | five hours | two hours | fifty hours | ten hours | ten hours |
| time | | | | | | | |
| Ic(A) | 39 | 38 | 39 | 39 | 31 | 30 | 26 |

It is effective for enhancing the Ic of the MgB₂ superconductive wire to make it higher than 650° C. which is the melting point of the Mg, and it is preferable to make it equal to or less than 850° C.

It should be further understood by those skilled in the art that although the foregoing description has been made on embodiments of the invention, the invention is not limited thereto and various changes and modifications may be made without departing from the spirit of the invention and the scope of the appended claims.

1. A manufacturing method of a MgB₂ superconductive wire comprising a step of producing a MgB₂ in accordance with a heat treatment by using a magnesium, and a magnesium boride expressed by MgBx (x=4, 7, 12) as a starting raw material.

2. A manufacturing method of a MgB₂ superconductive wire as claimed in claim 1, wherein the magnesium boride expressed by the MgBx (x=4, 7, 12) is filled in a tube made of the Mg or a magnesium alloy.

3. A manufacturing method of a MgB₂ superconductive wire as claimed in claim 1, wherein the step of the heat treatment makes at least a part of the magnesium boride expressed by the MgBx (x=4, 7, 12) be left.

4. A manufacturing method of a MgB₂ superconductive wire as claimed in claim 2, wherein the step of the heat treatment makes at least a part of the magnesium boride expressed by the MgBx (x=4, 7, 12) be left.

5. A manufacturing method of a MgB₂ superconductive wire as claimed in claim 1, wherein the MgB₂ is included as the starting raw material.

6. A manufacturing method of a MgB₂ superconductive wire as claimed in claim 5, wherein the MgB₂ included in the starting raw material is equal to or more than 1 weight % and equal to or less than 50 weight %.

7. A manufacturing method of a MgB₂ superconductive wire as claimed in claim 1, wherein the step of the heat treatment is carried out at a temperature equal to or more than 650° C.

8. A manufacturing method of a MgB₂ superconductive wire as claimed in claim 2, further comprising a step of drawing a wire before the step of the heat treatment after the step of the filling.

9. A manufacturing method of a MgB₂ superconductive wire as claimed in claim 2, further comprising a step of combining the wire in a sheath member so as to form multiple cores before the step of the heat treatment after the step of the filling.

10. A MgB₂ superconductive wire characterized in that a magnesium boride expressed by MgBx (x=4, 7, 12) is provided in at least a part of a cross section of the wire, and MgB₂ is provide in the periphery of the magnesium boride expressed by the MgBx.

11. A MgB₂ superconductive wire as claimed in claim 10, wherein the magnesium boride expressed by the MgBx and the MgB₂ portion are connected continuously in a longitudinal direction of the wire.

12. A MgB₂ superconductive wire as claimed in claim 10, wherein a boron simple substance is not included.

13. A MgB₂ superconductive wire as claimed in claim 10, wherein a sheath member is provided in the periphery of the MgB₂ portion.

14. A MgB₂ superconductive wire as claimed in claim 13, wherein a plurality of superconductive filaments are provided in one sheath member
